(19) United States
(12) Patent Application Publication
(10) Pub. No.: US 2012/0106137 A1
(43) Pub. Date: May 3, 2012

(54) THERMAL PIPE CAP

(75) Inventors: Keith Scott, Livermore, CA (US); Todd Farmer, Livermore, CA (US)

(73) Assignee: BRIDGELUX, INC., Livermore, CA (US)

(21) Appl. No.: 13/291,765

(22) Filed: Nov. 8, 2011

Related U.S. Application Data
(60) Provisional application No. 61/412,757, filed on Nov. 11, 2010.

(51) Int. Cl. F21S 8/04

(52) U.S. Cl. 362/147

(57) ABSTRACT

A light fixture includes a body, a hollow arm extending out from the body, a pipe cap at a distal end of the arm, and one or more solid state light emitting devices supported by the pipe cap. The pipe cap thermally couples the one or more solid state light emitting devices to the arm.

### CROSS REFERENCE TO RELATED APPLICATIONS

This application claims priority from U.S. provisional application serial number 61/412,757, filed on Nov. 11, 2010, titled “THERMAL PIPE CAP,” and is incorporated herein by reference.

### BACKGROUND

1. Field

The present disclosure relates to illumination devices. More particularly, the disclosure relates to heat dissipation in elongated light fixtures using solid state light emitting devices.

2. Background

An elongated light fixture can be described as having a light source connected to a power source by use of multiple hollow arms that branch out from the center of the fixture. A chandelier is a decorative ceiling- or wall-mounted light fixture with such characteristics. Traditionally, each arm carries an incandescent or halogen lamp at its distal end. Solid state light emitting devices, such as light emitting diodes (LEDs), are attractive candidates for replacing such conventional light sources. LEDs have substantially higher light conversion efficiencies than incandescent and halogen lamps and longer lifetimes than either of these types of conventional light sources.

LEDs require lower voltages than traditional lamps and contain no mercury or other potentially dangerous materials, therefore, providing various safety and environmental benefits.

The problem is that these light fixtures do not provide an efficient means for dissipating heat generated by solid state light emitting devices.

### SUMMARY

In an embodiment, a light fixture includes a body, a hollow arm, often called a pipe, extending out from the body, a pipe cap at a distal end of the arm, and one or more solid state light emitting devices supported by the pipe cap. The pipe cap thermally couples the one or more solid state light emitting devices to the arm.

### BRIEF DESCRIPTION OF THE DRAWINGS

FIG. 1 shows an embodiment of a light fixture including hollow aims to support thermal pipe caps and solid state light emitting devices;

FIG. 2 is a conceptual cross-sectional view illustrating an example of a solid state light emitting device (LED);

FIG. 3 is a conceptual top view illustrating an example of an array of LEDs forming a light emitting element;

FIG. 4A is a conceptual top view illustrating an example of an array of LEDs coated with a phosphor to form a white light solid state light emitting device;

FIG. 4B shows a conceptual cross-section view of the solid state light emitting device of FIG. 4A;

FIG. 5A illustrates a conceptual cross-section view of an example of a thermal pipe cap on a light fixture arm;

FIG. 5B illustrates a conceptual cross-section view of an example of a snap fit attachment of the thermal pipe cap of FIG. 5A to the light fixture arm;

FIG. 5C illustrates a conceptual cross-section view of an example of a screw thread attachment of the thermal pipe cap of FIG. 5A to the light fixture arm;

FIG. 6A illustrates a conceptual cross-section view of a first example of a thermal pipe cap with triangular heat dissipation fins.

FIG. 6B illustrates a plan view of the thermal pipe cap of FIG. 6A;

FIG. 7A illustrates a conceptual cross-section view of a second example of a thermal pipe cap with rectangular heat dissipation fins; and

FIG. 7B illustrates a plan view of the thermal pipe cap of FIG. 7A.

### DETAILED DESCRIPTION

The present invention is described more fully hereinafter with reference to the accompanying drawings, in which various aspects of the present invention are shown. This invention, however, may be embodied in many different forms and should not be construed as limited to the various aspects of the present invention presented throughout this disclosure. Rather, these aspects are provided so that this disclosure will be thorough and complete, and will fully convey the scope of the present invention to those skilled in the art. The various aspects of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method.

Various aspects of the present invention will be described herein with reference to drawings that are schematic illustrations of idealized configurations of the present invention. As such, variations from the shapes of the illustrations as a result, for example, manufacturing techniques and/or tolerances, are to be expected. Thus, the various aspects of the present invention presented throughout this disclosure should not be construed as limited to the particular shapes of elements (e.g., regions, layers, sections, substrates, etc.) illustrated and described herein but are to include deviations in shapes that result, for example, from manufacturing. By way of example, an element illustrated or described as a rectangle may have rounded or curved features and/or a gradient concentration at its edges rather than a discrete change from one element to another. Thus, the elements illustrated in the drawings are schematic in nature and their shapes are not intended to illustrate the precise shape of an element and are not intended to limit the scope of the present invention.

It will be understood that when an element such as a region, layer, section, substrate, or the like, is referred to as being “on” another element, it can be directly on the other element or intervening elements may also be present. In contrast, when an element is referred to as being “directly on” another element, there are no intervening elements present. It will be further understood that when an element such as a structure is referred to as being coupled to another element, it can be directly connected to the other element or intervening elements may also be present. For example, one element may be electrically coupled to another by direct conductive connection, or there may be an intervening electrically conductive connector, a capacitive, inductive or other form of connection which provides for transmission of electrical current, power, signal or equivalents. Similarly, two elements may be mechanically coupled by being either directly physically connected, or intervening connecting elements may be present. It will be further understood that when an element is referred to as being “formed” on another element, it can be grown, deposited, etched, attached, connected, coupled, or otherwise prepared or fabricated on the other element or an intervening element.

Furthermore, relative terms, such as “lower” or “bottom” and “upper” or “top,” may be used herein to describe one element's relationship to another element as illustrated in the drawings. It will be understood that relative terms are intended to encompass different orientations of an apparatus in addition to the orientation depicted in the drawings. By way of example, if an apparatus in the drawings is turned over, elements described as being on the “lower” side of other elements would then be oriented on the “upper” side of the other elements. The term “lower”, can therefore, encompass both an orientation of “lower” and “upper,” depending of the particular orientation of the apparatus. Similarly, if an apparatus in the drawing is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

The detailed description set forth below in connection with the appended drawings is intended as a description of various aspects of the present invention and is not intended to represent all aspects in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention.

Various aspects of a light source will now be presented. However, as those skilled in the art will readily appreciate, these aspects may be extended to other apparatus without departing from the spirit and scope of the invention. The light source may include a series of solid state light emitting devices mounted on a universal mounting carriage. The universal mounting carriage is configured to replace one or more parts of the illumination system in any of a plurality of available housing heads for lighting. The plurality of housing heads may differ in at least one dimension, and the illumination systems may also vary in illumination pattern and intensity requirements.

Disclosed is an apparatus and method for mounting a thermally conductive pipe on a distal end of a light fixture arm, where the pipe cap supports a solid state light emitting device, such as an LED or LED array. LEDs are representative of one of solid state light emitting devices, and are described with reference to the various embodiments without loss of generality pertaining to solid state emitting devices.

An example of a solid state light emitting device for used in solid state light emitting devices is the light emitting diode (LED). The LED is well known in the art, and therefore, will only briefly be discussed to provide a complete description of the invention. An LED is a semiconductor material impregnated, or doped, with impurities. These impurities add “electrons” and “holes” to the semiconductor, which can move in the material relatively freely. Depending on the kind of impurity, a doped region of the semiconductor can have predominantly electrons or holes, and is referred to as n-type or a p-type semiconductor region, respectively. In LED applications, the semiconductor includes an n-type semiconductor region and a p-type semiconductor region. A reverse electric field is created at the junction between the two regions, which cause the electrons and holes to move away from the junction to form an active region. When a forward voltage sufficient to overcome the reverse electric field is applied across the p-n junction, electrons and holes are forced into the active region and combine. When electrons combine with holes, they fall to lower energy levels and release energy in the form of light.

LEDs are available in a range of colors of relatively narrow bandwidth. However, in applications where it is desirable to simulate illumination spectral properties representative of “white light” produced by incandescent, fluorescent, halogen or natural sunlight, one solution is to include one or more phosphors in a carrier encapsulating, or as a layer above, a blue LED. The phosphors absorb a portion of the short wavelength blue light and emit longer wavelengths of light by a process of Stokes shift emission. By controlling the type and amount of phosphor a balanced mix of light emitted by the LED directly and the phosphor is perceived by the human eye as “white light.”

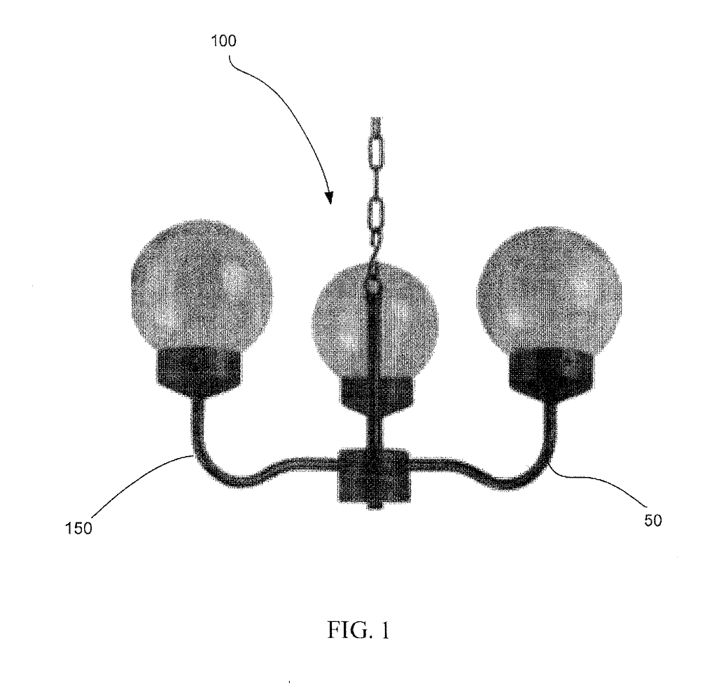

FIG. 1 shows an embodiment of a light fixture 100 including a plurality of hollow arms 150 to support thermal pipe caps and solid state light emitting devices. The solid state light emitting devices are described below.

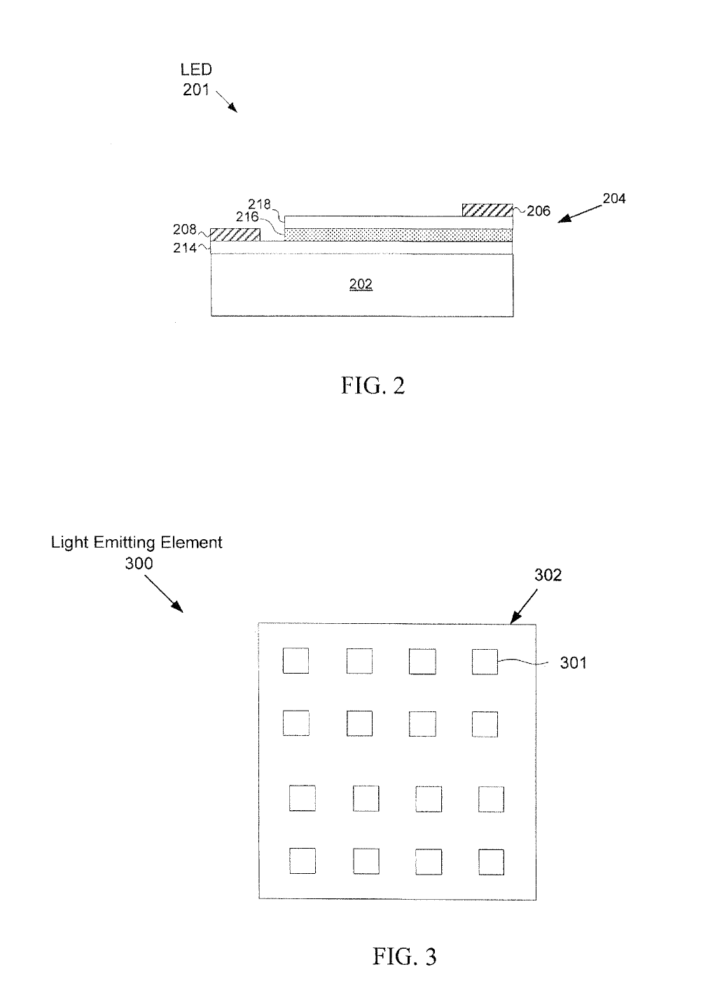

Referring to FIG. 2, the LED 201 includes a substrate 202, an epitaxial-layer structure 204 on the substrate 202, and a pair of electrodes 206 and 208 on the epitaxial-layer structure 204. The epitaxial-layer structure 204 comprises an active region 216 sandwiched between two oppositely doped epitaxial regions. In this example, an n-type semiconductor region 214 is formed on the substrate 202 and a p-type semiconductor region 218 is formed on the active region 216, however, the regions may be reversed. That is, the p-type semiconductor region 218 may be formed on the substrate 202 and the n-type semiconductor region 214 may formed on the active region 216. As those skilled in the art will readily appreciate, the various concepts described throughout this disclosure may be extended to any suitable epitaxial-layer structure. Additional layers (not shown) may also be included in the epitaxial-layer structure 204, including but not limited to buffer, nucleation, contact and current spreading layers as well as light extraction layers.

The electrodes 206 and 208 may be formed on the surface of the epitaxial-layer structure 204. The p-type semiconductor region 218 is exposed at the top surface, and therefore, the p-type electrode 206 may be readily formed thereon. However, the n-type semiconductor region 214 is buried beneath the p-type semiconductor region 218 and the active region 216. Accordingly, to form the n-type electrode 208 on the n-type semiconductor region 214, a portion of the active region 216 and the p-type semiconductor region 218 is removed to expose the n-type semiconductor region 214 therebeneath. After this portion of the epitaxial-layer structure 204 is removed, the n-type electrode 208 may be formed.

As discussed above, one or more light emitting devices may be used to construct an LED array. One example of an LED array will now be presented with reference to FIG. 3. FIG. 3 is a conceptual top view illustrating an example of an LED array used to form a light emitting element. In this example, a light emitting element 300 is configured with multiple LEDs 301 arranged on a substrate 302. The substrate 302 may be made from any suitable material that provides mechanical support to the LEDs 301. Preferably, the material is thermally conductive to dissipate heat away from the LEDs 301. The substrate 302 may include a dielectric layer (not shown) to provide electrical insulation between the LEDs 301. The LEDs 301 may be electrically coupled in parallel and/or series by a conductive circuit layer, wire bonding, or a combination of these or other methods on the dielectric layer.

The LED array may be configured to produce white light. White light may enable the LED array to act as a direct replacement for conventional light sources used today in incandescent, halogen, fluorescent, HID, and other suitable lamps. There are at least two common ways of producing white light. One way is to use individual LEDs that emit wavelengths (such as red, green, blue, amber, or other colors) and then mix all the colors to produce white light. The other way is to use a phosphor material or materials to convert monochromatic light emitted from a blue or ultra-violet (UV) LED to broad-spectrum white light. The present invention, however, may be practiced with other LED and phosphor combinations to produce different color lights.

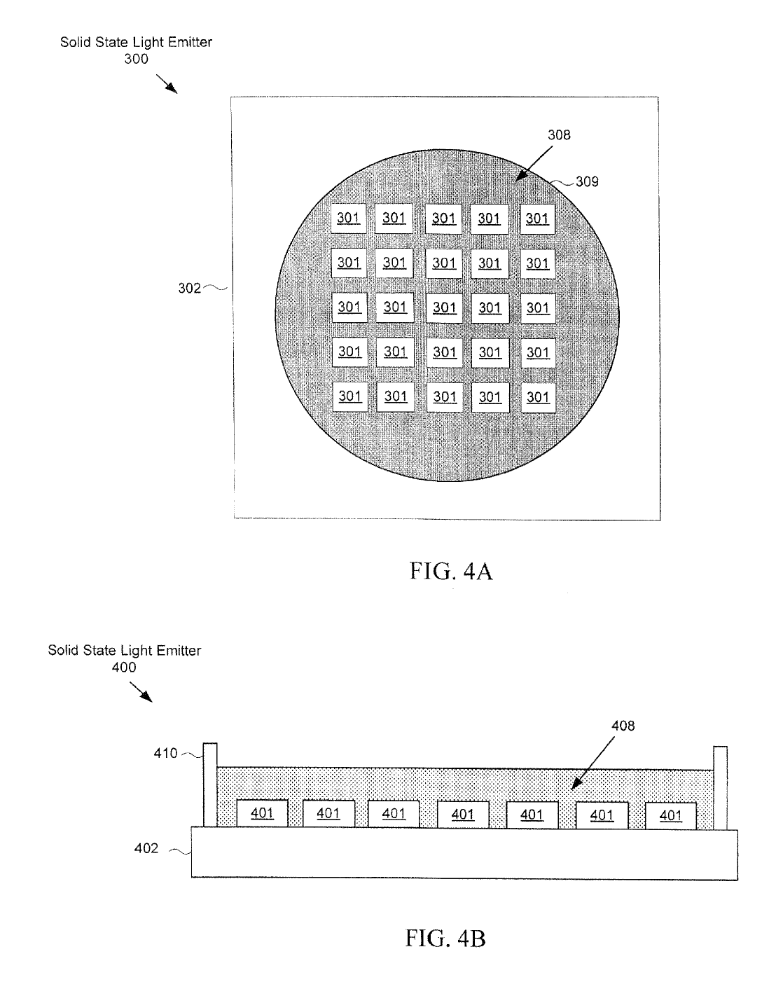

An example of a LED array will now be presented with reference to FIGS. 4A-4B. FIG. 4A is a conceptual top view illustrating an example of a white light LED array, now referred to as a solid state light emitting device and FIG. 4B is a conceptual cross-sectional side view of the solid state light emitting device in FIG. 4A. The solid state light emitting device 400 is shown with a substrate 402 which may be used to support multiple LEDs 401. The substrate 402 may be configured in a manner similar to that described in connection with FIG. 3 or in some other suitable way. In this example, the substrate 402 includes a plurality of slots 410 along the periphery. A phosphor material 408 may be deposited within a cavity defined by an annular, or other shaped, or other boundary 409 that extends circumferentially, or in any shape, around the upper surface of the substrate 402, such as may be defined, for example, by the slots 410. The annular boundary 409 may be formed with a suitable mold, or alternatively, formed separately from the substrate 402 and attached to the substrate 402 using an adhesive or other suitable means. The phosphor material 408 may include, by way of example, phosphor particles suspended in an epoxy, silicone, or other carrier or may be constructed from a soluble phosphor that is dissolved in the carrier.

In an alternative configuration of a white light emitting element, each LED 401 may have its own phosphor layer. As those skilled in the art will readily appreciate, various configurations of LEDs and other light emitting devices may be used to create a white light emitting element. Moreover, as noted earlier, the present invention is not limited to solid state lighting devices that produce white light, but may be extended to solid state lighting devices that produce other colors of light.

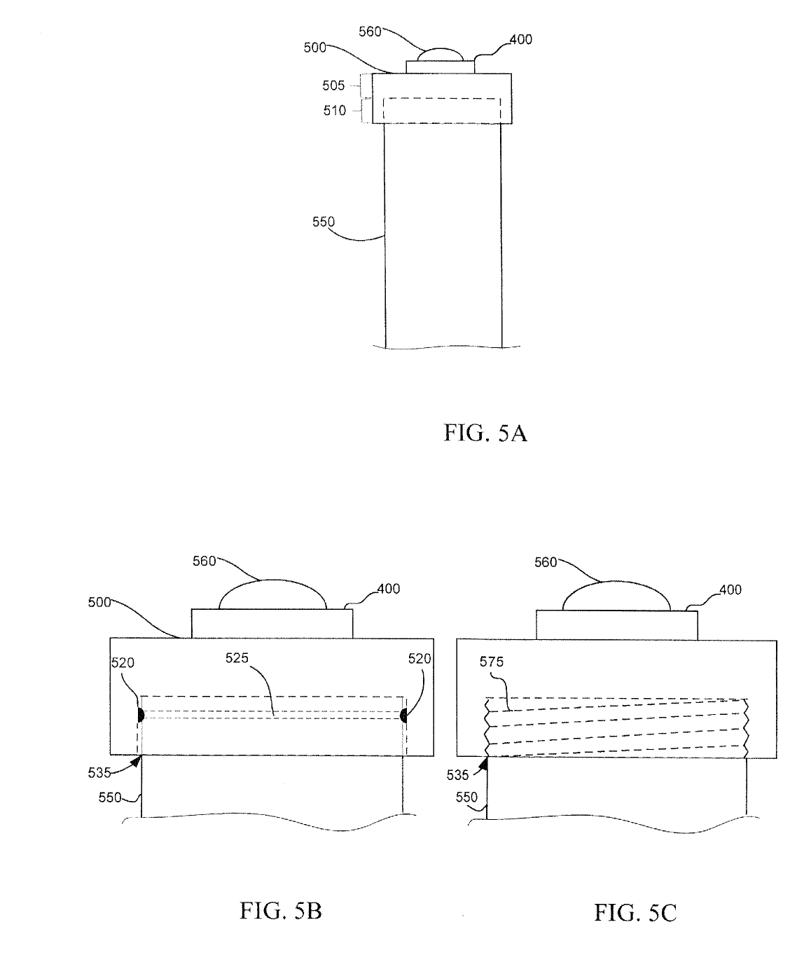

Referring to FIG. 5A, a solid state light emitting device 400 may be attached to a thermally conductive pipe cap 500. Electrically conductive wires 501 may be incorporated in the pipe cap 500 to connect to the solid state light emitting device for delivering power. The pipe cap 500 may be mounted to the distal end of an arm 550 to provide a thermal path between the solid state light emitting device 400 and the arm 550. The pipe cap 500 may be configured to carry optics 560 that work together with the solid state light emitting device 400 to obtain a specified illumination pattern. The pipe cap 500 may be formed as a disk 505 that supports the solid state light emitting device 400 and optics 560. The disk 505 may be circular, polygonal, or any shape that conforms and is suitable for attachment to the arm 550. The disk 505 may have dimensions slightly larger than the cross-section of the arm 550. In one embodiment, as shown in FIG. 5A, a overhanging portion 510 extends vertically downward from the edge of the disk 505, encompassing the outer surface of the arm 550, thereby providing either a thermally conductive secure fit as shown in FIG. 5B, where a circular ridge 520 mates with a circular groove 525 or, as shown in FIG. 5C, a thermally conductive screw connection 575 to the exterior portion of the light fixture arm 550. A thermal interface material 535 may be applied between the overhanging portion 510 of the cap 500 and the arm 550 to improve the thermal conductivity. Examples of thermal interface material include, but are not limited to, thermal grease, phase change material, thermal pad, gap pad, thermal tape, any combination thereof, and the like. However, where the cross-section of the arm 550 is not circular, the overhanging portion 510 has a shape consistent with fitting securely to the arm 550. For the sake of discussion, embodiments are described with respect to circular disks 505 and arms 550 without loss of generality.

An environmentally protective feature 590 may be placed over the solid state emitting device 400 to protect against various environmental elements that may degrade the performance of the solid state light emitting device 400. The feature 590 may be attached to the solid state light emitting device 400, the pipe cap 500, the arm 550, or any combination thereof. The feature 590 may be at least one of a sealed transparent cap, a translucent cap, a screen, or the like, and any combination thereof, to protect the solid state light emitting device 400 from moisture, dirt, fungus, air pollution, objects, insects and creatures, or the like.

Feature 590 may further be an optical element configured to guide or diffuse the light from the solid state light emitting device 400. The objective is to direct or disperse the light in an intended fashion. The dispersal of light by feature 590 may be a specified pattern or a diffusing effect to provide greater/lesser light spreading or to control glare.

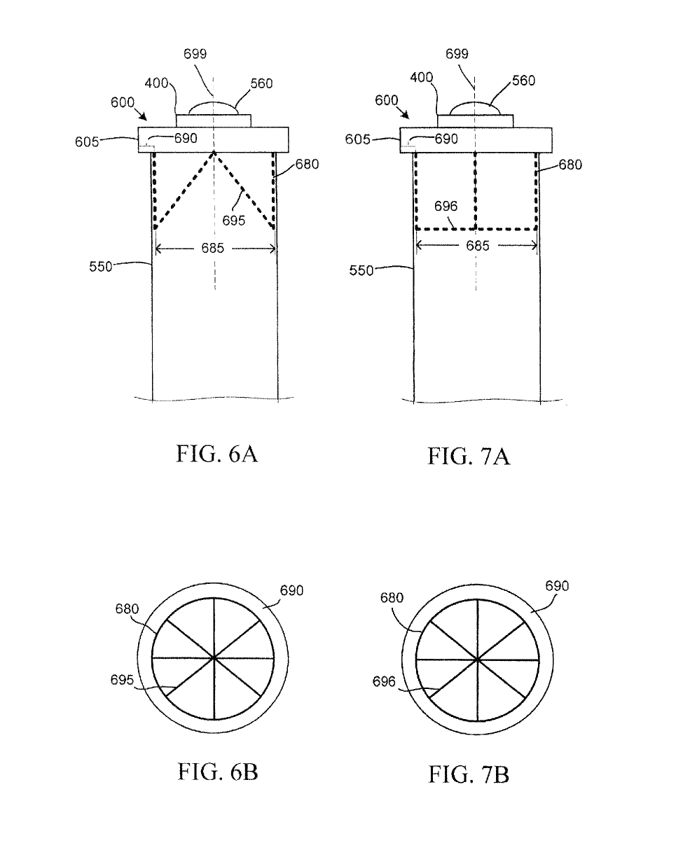

In another embodiment, as shown in FIG. 6A and 6B, a disk 605 of a pipe cap 600 may be coupled to a vertically downward extending substantially hollow insertable portion 680 that has a diameter 685 that is slightly smaller than the diameter of the aim 550, thereby creating a rim 690 around the periphery of the disk 605, similar to disk 505. In this embodiment, the insertable portion 680 of the pipe cap 500 may be inserted into the arm 550 until the rim 690 of the cap 600 rests on the distal end of the arm 550. Preferably, the insertable portion 680 is sized to support a secure fit into the arm 550, whereby the insertion force alone holds the cap 600 in place. The secure fit may include any one of a conformal fit, snap fit, compression fit, screw-on, adhesives, or any means appropriate to affix the cap to the arm 550. A thermal interface material 635 may be applied between the insertable portion 680 and the arm 550 to improve the thermal connection.

The pipe cap 600 may include a series of thermally conductive fins 695, as shown in FIGS. 6A-6B, that extend at a downward angle from the center of the disk 605 to the insertable portion 680. Thus, the fins 695 have a triangular appearance, with one edge attached at the insertable portion 680, one edge attached at the interior (e.g., underside) of the disk 605 from the disk center, indicated by a center line 699 to the insertable portion 680, and the third edge extending from the disk 605 from the center line 699 to the distal edge of the insertable portion 680. The fins may be arranged symmetrically with respect to the center line 699. The fins 695 provide both structural support for the LED (or LED array) and an additional thermal path between the LED (or LED array) and the arm 550 of the light fixture 100.

In Another embodiment, as shown in FIGS. 7A and 7B, fins 795 may have a rectangular shape, arranged from the center line 699 of the disk 605 to the insertable portion 680, and attached to the disk 605 from the center line 699 to the proximal end of the insertable portion 680.

The claims are not intended to be limited to the various aspects of this disclosure, but are to be accorded the full scope consistent with the language of the claims. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A light fixture, comprising:
a body;
a hollow arm extending out from the body;
a pipe cap at a distal end of the arm; and
one or more solid state light emitting devices supported by the pipe cap;
wherein the pipe cap thermally couples the one or more solid state light emitting devices to the arm.

2. The light fixture of claim 1 further comprising electrically conductive wires incorporated in the pipe cap to connect to the solid state light emitting devices configured to deliver power.

3. The light fixture of claim 1 further comprising one or more optics supported by the pipe cap.

4. The light fixture of claim 1 further comprising an environmentally protective feature supported by the arm.

5. The light fixture of claim 4, wherein the protective feature is at least one of a sealed transparent cap, a sealed translucent cap, and a screen.

6. The fixture of claim 1 further comprising an optical feature supported by the arm.

7. The light fixture of claim 5, wherein the optical feature is configured to disperse, diffuse and/or guide the emitted light according to a selected intent.

8. The light fixture of claim 1 wherein the pipe cap comprises a disk portion and an overhanging portion extending from an edge of the disk portion.

9. The light fixture of claim 5 wherein the overhanging portion of the pipe cap surrounds an exterior portion of the distal end of the arm and is in thermal contact therewith.

10. The light fixture of claim 5 wherein the pipe cap comprises a substantially hollow insertable portion into the distal end of the arm, the insertable portion having a proximal end coupled to the disk portion and a distal end, the hollow portion being in thermal contact with an interior wall portion of the distal end of the arm.

11. The light fixture of claim 9 wherein the overhanging portion of the pipe cap securely fits onto the distal end of the arm.

12. The light fixture of claim 9 wherein the overhanging portion of the pipe cap is threaded onto the distal end of the arm.

13. The light fixture of claim 9, further comprising a thermal interface material between the overhanging portion of the pipe cap and the arm.

14. The light fixture of claim 10 wherein the pipe cap comprises a plurality of thermally conductive fins extending from the disk portion of the pipe cap to the insertable portion the pipe cap.

15. The light fixture of claim 10 wherein the pipe cap comprises a solid core extending from the disk portion of the pipe cap to the insertable portion the pipe cap

16. The light fixture of claim 10 wherein the pipe cap comprises a hollow pipe extending from the disk portion of the pipe cap to the insertable portion the pipe cap.

17. The light fixture of claim 14 wherein each of the thermally conductive fins of the pipe cap comprises a first edge extending between the proximal and distal ends of the insertable portion and along at least a portion of the insertable portion, a second edge extending from the first edge along an interior portion of the disk from the insertable portion proximal end to a center of the disk, and a third edge extending from the center of the disk to the distal end of the insertable portion at the first edge.

18. The light fixture of claim 14 wherein each of the thermally conductive fins of the pipe cap comprises a first edge extending between the proximal and distal ends of the insertable portion and along at least a portion of the insertable portion, a second edge extending from the first edge along an interior portion of the disk from the insertable portion proximal end to a center of the disk, a third edge extending from the distal end of the first insertable portion radially inward to a central axis of the disk , and a fourth edge extending from the third edge along the central axis to the center of the disk.

19. The light fixture of claim 14 wherein the thermally conductive fins of the pipe cap provide a thermal pathway between the one or more solid state light emitting devices and the arm.

20. The light fixture of claim 14 wherein the thermally conductive fins of the pipe cap provide structural support for the one or more solid state light emitting devices.
